(19) United States
(12) Patent Application Publication
(10) Pub. No.: US 2006/0049281 A1
(43) Pub. Date: Mar. 9, 2006

(54) Nozzle for spraying liquid substances, dispersions, emulsions, or suspensions

(75) Inventors: Michael Jacob, Weimar (DE); Karlheinz Rumpler, Weimar (DE); Mike Waskow, Weimar (DE)

Correspondence Address: VOLPE AND KOENIG, P.C., UNITED PLAZA, SUITE 1600, 30 SOUTH 17TH STREET, PHILADELPHIA, PA, 19103, US

(73) Assignee: Glatt Ingenieurtechnik GmbH, Weimar (DE)

(21) Appl. No.: 10/538,864

(22) PCT Filed: Mar. 18, 2004
(86) PCT No.: PCT/EP04/02798

§ 371 Date: Jun. 14, 2005

(30) Foreign Application Priority Data
Apr. 4, 2003 (DE) 10315386.1

(51) Int. Cl. B05B 7/06

(52) U.S. Cl. 239/463; 239/424

(57) ABSTRACT

A nozzle for spraying liquid substances, dispersions, emulsions or suspensions into a fluidized granulator system is provided. The invention provides a generic nozzle, especially for use in the food industry and chemical industry which has good accessibility while being easy to disassemble and assemble without great effort for a required cleaning process. The inner tube (3) of the nozzle is mounted inside a receiving block (11) that is detachably fastened to a tube (10) which is disposed in a fixed manner in a bottom area of a base lance member (9) and can be removed therefrom along with the inner tube (3) and any add-on pieces possibly joined to the inner tube. A fastening device (8) detachably connects the nozzle to the process housing (15) of the fluidized bed granulator system and is arranged in the bottom area of the outer tube (2) of the nozzle.

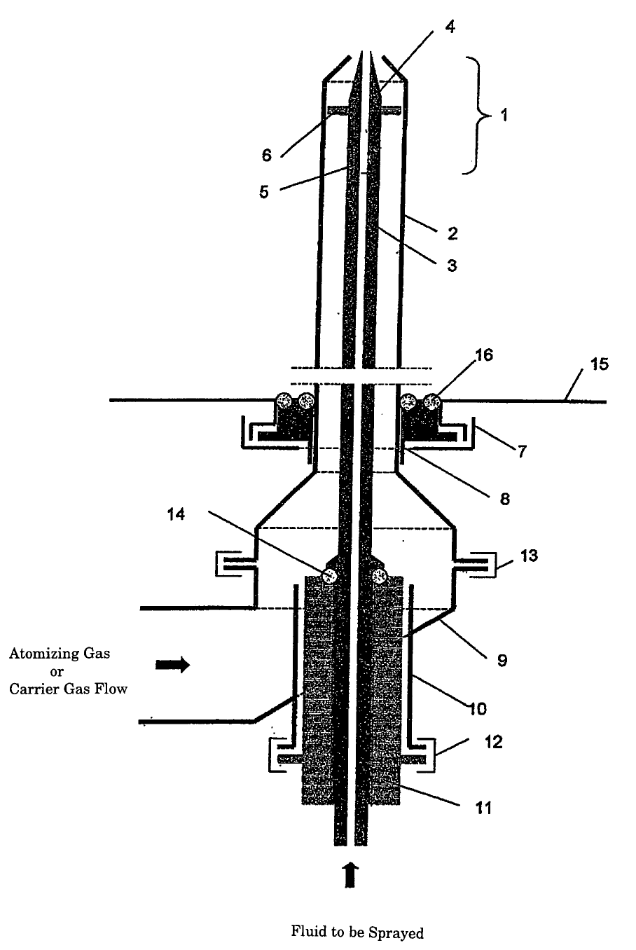

### BACKGROUND

The invention relates to a nozzle for spraying liquid substances, dispersions, emulsions, or suspensions with the features noted in the preamble of claim 1.

Nozzle constructions for spraying liquid substances, dispersions, emulsions, or suspensions into a fluidized bed granulating system are generally known. The appropriate nozzle constructions are especially adapted to the field of application of materials to be produced in the fluidized bed granulating system. For example, two-component nozzles are known, which usually include a centrally arranged inner tube and an outer tube spaced apart from this inner tube. The liquid substance to be sprayed into the fluidized bed is fed to the inner tube, while an atomizing gas is fed to the outer tube.

Corresponding to the material to be produced, it is also known to provide the nozzle as a three-component or four-component atomizing nozzle, or, in general, as a multi-component atomizing nozzle. In this way, the materials to be atomized differently and the atomizing gas are fed into the resulting intermediate spaces between the individual tubes or channels.

A disadvantage in these nozzles is their difficult cleaning, because the nozzles are difficult to access and must be built with large expense for cleaning. Especially in the food industry and in other intensely hygienic industries, as well as in the chemical industry, high demands are placed on the cleanliness of the system, so that it is necessary to subject the nozzles to cleaning processes at certain intervals.

### SUMMARY

The objective of the invention is to create a nozzle according to the class for use in the food and chemical industries, which is distinguished by good accessibility and which can be easily disassembled and assembled for a necessary cleaning process without great expense.

This objective is solved according to the invention by the characterizing features of claim 1.

According to the invention, because the inner tube of the nozzle is mounted in a receiving block, which is attached detachably in a tube arranged in a fixed manner on the bottom region of a lance base and which can be removed from this tube with the inner tube and the add-on parts possibly attached to the inner tube, and because an attachment device, which connects the nozzle detachably to the processing housing of the fluidized-bed granulating system, is arranged at the bottom region of the outer tube of the nozzle, the nozzle can be disassembled with a few hand movements and the individual parts can be subjected to a corresponding cleaning process. Through the arrangement of the corresponding attachment means, good accessibility to these means is also given, so that the nozzle can be quickly uninstalled and also reinstalled.

Additional advantageous configurations are described in the subordinate claims. They are explained together with their effect in the description.

### BRIEF DESCRIPTION OF THE DRAWINGS

The invention is explained in more detail below with reference to an embodiment. In the associated drawing, a nozzle for spraying liquid substances, dispersions, emulsions, or suspensions into a fluidized-bed granulating system is illustrated schematically.

### DETAILED DESCRIPTION OF THE PREFERRED EMBODIMENT

The solution according to the invention is explained using a known two-component nozzle. The solution according to the invention can also be used analogously for three-component or four-component nozzles.

The known two-component nozzle includes a cylindrical nozzle body, which is formed from a central inner tube 3 and an outer tube 2 spaced apart from this inner tube, and of a nozzle mouth piece 1. The inner tube 3 is connected with its bottom end to a supply for the material to be sprayed, while the atomizing gas is fed to the nozzle mouth piece 1 via the intermediate space produced between the inner tube 3 and the outer tube 2.

According to the invention, the inner tube 3 is mounted in a receiving block 11, which is attached in a tube 10 arranged in a fixed manner at the bottom region of a lance base 9. The receiving block 11 is detachably attached, for example, by means of a tri-clamp attachment 12, to the tube 10, so that the receiving block 11 can be removed from the nozzle with the inner tube 3 and the add-on parts 6 attached to the inner tube after loosening the attachment 12 for cleaning purposes. The attachment of the inner tube 3 on the receiving block 11 can be realized in the simplest case by welding the inner tube 3 with the receiving block 11.

It is especially advantageous to screw the inner tube 3 into the receiving block 11. In this way, the possibility arises of setting the axial position of the inner tube 3, or of a liquid insert 4 to be explained in even more detail, in the region of the nozzle mouth piece 1 variable relative to the outer tube 2. By setting the inner tube 3 in the axial direction, the spray angle and the spray pattern of the nozzle can be set continuously from the outside. For such a setting possibility of the inner tube 3, the seal 14 between the receiving block 11 and the inner tube 3 within the lance base 9 is a metal compensator or an elastic O-ring in order to be able to seal the entire adjustment path hygienically.

For realizing different spraying conditions, the inner tube 3 is provided with an exchangeable liquid insert 4 in the region of the nozzle mouth piece 1. The seal between the exchangeable liquid insert 4 and the inner tube 3 is realized in an advantageous way by means of a simple metal seal set 5 in order to avoid sealing materials. In the region of the nozzle mouth piece 1, in the annular gap between the outer tube 2 and the liquid insert 4 or the inner tube 3, there is an add-on part 6 in the form of swirl bodies, swirl vanes, or the like. These add-on parts 6 are used for guiding the compressed air and for guiding the inner tube 3. The add-on part 6 is connected rigidly to the inner tube 3 or alternatively to the liquid insert 4 or to the outer tube 2.

The attachment of the nozzle on the processing housing 15 of the fluidized-bed granulating system is realized by means of an attachment device 8, which is arranged in the bottom region of the outer tube 2. The detachable attachment of the nozzle on the processing housing 15 is realized, for example, by a milk-tube union nut 7 or by means of a tri-clamp attachment. Here, the attachment device 8 is connected rigidly or adjustably to the outer tube 2 by means of a clamping sleeve. Between the outer tube 2 and the attachment device 8, as well as between the processing housing 15 and the attachment device 8, there is a seal 16. As the seal 16, O-rings or other hygienic seals can be used.

Through the attachment according to the invention of the nozzle onto the processing housing 15, the nozzle can be uninstalled and also reinstalled quickly and with minimal effort from the processing housing 15 for the purpose of cleaning.

The outer tube 2 is connected detachably, for example, by means of a tri-clamp attachment 13, to the lance base 9, whereby likewise a quick and uncomplicated disassembly and assembly of the parts is given. The outer tube 3 is provided in a region of the connection to the lance base 9 with an expanding diameter. A supply for the atomizing gas or for the support-gas stream opens in the base 9.

In summary, the following can be emphasized:

The invention relates to a nozzle for spraying liquid substances, dispersions, emulsions, or suspensions into a fluidized-bed granulating system.

The objective of the invention is to create a nozzle according to the class especially for use in the food and chemical industries, which is distinguished by good accessibility and which can be easily disassembled and assembled without great effort for a necessary cleaning process.

According to the invention, the inner tube of the nozzle is mounted in a receiving block, which is detachably attached in a tube in a fixed manner on the bottom region of a lance base and can be removed from this tube with the inner tube and add-on parts possibly attached to the inner tube, and an attachment device, which connects the nozzle detachably to the processing housing of the fluidized-bed granulating system, arranged at the bottom region of the outer tube of the nozzle.

1. Nozzle for spraying liquid substances, dispersions, emulsions, or suspensions, for use in fluidized-bed granulating systems, comprising the following:
the nozzle includes a cylindrical nozzle body and a nozzle mouth piece,
the nozzle body includes a centrally arranged inner tube and an outer tube spaced apart from the inner tube,
the inner tube is connected to a supply for a substance to be sprayed,
the outer tube is connected to a supply for an atomizing gas or to a carrier-gas stream and forms a lance base in a bottom region, and
the inner tube (3) is mounted in a receiving block (11), which is detachably attached in a tube (10) arranged in a fixed manner on a lower region of the lance base (9) and which can be removed from the tube with the inner tube (3) and any add-on parts (6) attached to the inner tube, and an attachment device (8), which connects the nozzle detachably to a processing housing (15) of the fluidized-bed granulating system, is arranged at a lower region of the outer tube (2).

2. Nozzle according to claim 1, wherein a seal (14) is arranged within the lance body (9) between the receiving block (11) and the inner tube (3).

3. Nozzle according to claim 1, wherein a seal (16) is arranged between the outer tube (2) and the attachment device (8), as well as between the processing housing (15) and the attachment device (8).

4. Nozzle according to claim 1, wherein in a region of the mouth piece (1) of the nozzle, the inner tube (3) is exchangeably connected to a liquid insert (4) using a metal seal set (5).

5. Nozzle according to claim 1, wherein in the region of the nozzle mouth piece (1), an add-on part (6) comprising swirl bodies, swirl vanes, or a guide for guiding compressed air and for guiding the inner tube (3) is arranged in an annular gap between the outer tube (2) and the liquid insert (4) or the inner tube (3) and is rigidly connected to the liquid insert (4) or to the outer tube (2).

6. Nozzle according to claim 1, wherein attachment of the nozzle on the process housing (15) comprises a milk-tube union nut (7) or a tri-clamp attachment.

7. Nozzle according to claim 1, wherein the outer tube (2) is detachably connected to the lance base (9).

8. Nozzle according to claim 1, wherein the outer tube (3) is provided in a region of connection to the lance base (9) with an expanding diameter.

9. Nozzle according to claim 1, wherein the receiving block (11) is connected to the tube (10) by a detachable connection.

10. Nozzle according to claim 1, wherein the inner tube (3) can be screwed into the receiving block (11) adjustable in a longitudinal axis direction for setting at least one of a spraying angle or a spraying pattern, wherein the seal (14) is provided for equalizing an adjustment path and comprises a metal compensator or an elastic O-ring.

11. Nozzle according to claim 1, wherein the inner tube (3) is welded to the receiving block (11).

12. Nozzle according to claim 7, wherein the outer tube is detachably connected to the lance base with a tri-clamp attachment.

13. Nozzle according to claim 9, wherein the receiving block is connected to the tube by a tri-clamp attachment.
